(19) United States
(12) Patent Application Publication
(10) Pub. No.: US 2015/0371201 A1
(43) Pub. Date: Dec. 24, 2015

(54) Electronic Payments

(71) Applicant: BARCLAYS BANK PLC, London, Greater London (GB)

(72) Inventors: Benjamin Edward READ, London (GB); Darren FOULDS, Hampshire (GB)

(21) Appl. No.: 14/765,637

(22) PCT Filed: Sep. 10, 2013
(86) PCT No.: PCT/GB2013/052369

§ 371 Date: Aug. 4, 2015

(30) Foreign Application Priority Data
Feb. 6, 2013 (GB) 1302100.1

(51) Int. Cl. G06Q 20/10

(52) U.S. Cl. CPC G06Q 20/10

(57) ABSTRACT

A method, application and system for transmitting electronic payment information, comprising the steps of receiving electronic payment information from a first party to a payment; receiving graphical content from the first party; combining the graphical content and the electronic payment information; and transmitting the combined graphical content and the electronic payment information to a second party to the payment.

### FIELD OF THE INVENTION

The present invention relates to a method and system for sending and receiving payments and payment information and in particular electronic payments.

### BACKGROUND OF THE INVENTION

Electronic payments and financial transactions may be made between individuals, between individuals and corporate entities or between corporate entities. Typically, such payments or transactions may be sent together with payment information including the parties to the transaction, the amount and a reference or payment identifier.

Whilst this payment information may be sufficient to identify the purpose of the payment, it may not provide an indication of the context of the payment or additional details useful or interesting to parties to the transaction.

Sending additional follow up information may be useful under certain circumstances, but this can be unreliable, especially if large numbers of payments or transactions are taking place. Furthermore, improving the usability and customer experience is important, especially for private individuals and so such financial systems and products may require additional enhancements to encourage their continued use.

Therefore, there is required a system and method that overcomes these problems.

### SUMMARY OF THE INVENTION

Against this background, there is provided a system and method in which user generated content, such as images and photographs, may be bound to payment information or payments and transfers. The sender or receiver of a payment may provide graphical content to be returned to the other party together with the payment or receipt of payment, for example. Therefore, the payment may be provided with additional context or information in the form the graphical content. The electronic payment may be peer-to-peer payments or other financial transactions.

In accordance with a first aspect there is provided a method of transmitting electronic payment information comprising the steps of:

receiving electronic payment or electronic payment information from a first party to a payment;

receiving graphical content from the first party;

combining the graphical content and the electronic payment information; and

transmitting the combined graphical content and the electronic payment information to a second party to the payment. Combining or binding graphical content to electronic payment information may improve usability and the customers' experience. It may also provide additional context to a payment and enable other value-added services. For example, an invoice for payment may contain an image of a service actually provided (e.g. cleaned windows). Confirmation of a payment may include a photograph of the sender or show a reason for the payment (e.g. a birthday cake). The graphical content may also provide additional information relevant to the payment (e.g. an advertisement for similar goods or services). The graphical content may be attached to the payment itself of payment information relating to a previously made payment (e.g. a receipt).

Preferably, the method may further comprise the step of restricting access to the graphical content only to the second party. This may improve privacy and security.

Preferably, the method may further comprise the step of saving the received graphical content. The received graphical content or image may be saved within an image server, for example, and then transmitted to the recipient or other party to the transaction.

Optionally, the electronic payment information may be selected from the group consisting of: invoice, bill, payment demand, receipt, and acknowledgment of payment. Other types of payments or payment information may be included.

Optionally, the graphical content may be an electronic image or a photograph. Other types of graphical content may be used.

Optionally, the graphical content may be hidden from the second party until the second party performs an action. The action may be to actively accept receipt of the graphical content or to press a button or make a detectable gesture, for example.

Advantageously, the action is rubbing over the image on a touch sensitive screen. In other words, this may involve making a rub-to-reveal gesture.

Optionally, the method may further comprise adding a hyperlink to the payment information. This may be a URL, shortcut, pointer or link to a specific network or Internet address.

Preferably, the hyperlink may direct the second party to a web site for administering the payment.

Optionally, administering the payment may relate to tax and/or charity. For example, this may be to register the payment or parties for gift aid.

Optionally, the graphical content may be animated.

Optionally, the first party may be a payee and the second party is may be a payer or wherein the first party is a payer and the second party is a payee.

Optionally, the method may further comprise the step of generating an authentication token following confirmation of the payment. The authentication token may be used to bind the payment (or payment information) with the graphical content, allow confirmation to be made that the graphical content is associated with a particular payment, or secure or restrict access to the graphical content.

Preferably, the graphical content and the payment information may be combined or bound using the authentication token.

Optionally, the method may further comprise the step of saving the graphical content together with the authentication token. The authentication token may be a hash or cryptographic material, for example.

Optionally, the graphical content and payment information may be combined using an authentication token and further wherein transmitting the combined graphical content and payment information comprises the second party to the payment using the authentication token to request the graphical content. This allows the graphical content to be requested separately, whilst restricting access to the intended recipient.

According to a second aspect, there is provided an application for transmitting electronic payment information, the application comprising logic configured to:

receive electronic payment information from a first party to a payment;

receive graphical content from the first party;

combine the graphical content and the electronic payment information; and

transmit the combined graphical content and the electronic payment information to a second party to the payment.

Preferably, the application is a mobile application executable on a mobile device. The application may be mobile application or other executable software operating on suitable device, preferably a smart phone. The application may operate within an operating system such as iOS™ or Android™ on suitable hardware (e.g. an iPhone), for example. The application may operate on other devices or computer systems.

Optionally, the combined graphical content and the electronic payment information may be transmitted to the second party to the payment through a payment server and an image server. These may be separate devices or part of the same hardware.

Preferably, the logic may be further configured to receive combined graphical content and electronic payment information. Therefore, the application may both send and receive payments with attached graphical content.

Optionally, the graphical content and the payment information may be combined using an authentication token and wherein receiving the graphical content may comprise requesting the graphical content using the authentication token.

According to a third aspect, there is provided a system for transmitting electronic payment information comprising a server configured to:

receive electronic payment information and graphical content from a first party to a payment;

combine the electronic payment information and graphical content; and

transmit the combined electronic payment information and graphical content to a second party to the payment. The system may include many devices, each running an application, one or more servers and associated networking devices and apparatus.

Preferably, the system may further comprise a payment server (e.g. peer-to-peer payment server) and image server and wherein the combined electronic payment information and graphical content are transmitted through the payment server and image server respectively. The payment server and/or the image server may be separate logical devices within the same physical device or be separate hardware.

Optionally, the system may further comprise a hardware security module, HSM, configured to encrypt the graphical content. This may further improve security.

The methods described above may be implemented as a computer program comprising program instructions to operate a computer. The computer program may be stored on a computer-readable medium.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a flow diagram of a method for adding graphical content to a payment;

FIG. 2 shows a flow diagram of a method for receiving payment information together with the graphical content of FIG. 1;

FIG. 3 shows a schematic diagram of a system for adding graphical content to payment information;

FIG. 4 shows a sequence diagram of a method for adding graphical content to the payment;

FIG. 5 shows a sequence diagram of a method for receiving an image with payment information;

FIG. 6 shows a screen shot of a mobile application used to add graphical content to a peer-to-peer payment;

FIG. 7 shows a further screen shot of a mobile application used to add graphical content to a peer-to-peer payment;

FIG. 8 shows a further screen shot of a mobile application used to add graphical content to a peer-to-peer payment;

FIG. 9 shows a further screen shot of a mobile application used to add graphical content to a peer-to-peer payment;

FIG. 10 shows a further screen shot of a mobile application used to add graphical content to a peer-to-peer payment;

FIG. 11 shows a further screen shot of a mobile application used to add graphical content to a peer-to-peer payment;

FIG. 12 shows a further screen shot of a mobile application used to add graphical content to a peer-to-peer payment; and

FIG. 13 shows a further screen shot of a mobile application used to add graphical content to a peer-to-peer payment.

It should be noted that the figures are illustrated for simplicity and are not necessarily drawn to scale.

### DETAILED DESCRIPTION OF THE PREFERRED EMBODIMENTS

Automated payment systems allow transactions to be securely conducted between parties. Such systems are typically deployed within banks and other financial institutions. These automated payments systems are well known and so shall not be described further. Payments described in the following description may be executed by such automated payment systems (e.g. BACS, CHAPS or internal account transfers).

User generated content may be attached to a payment by a sender or payer and may be viewed by the person receiving the payment. The user generated content may be made up of graphical content such as a picture (which may be taken by an onboard camera or uploaded from pictures already on a device), an optional custom message and an optional wrap option. The wrap option may control how payment details may be displayed to users e.g. as a ‘Present’ or a ‘Scratch to reveal’ panel. Example payments may be classified as:
Standard payments—payments with no images attached
Image only payments—payments with images attached that are not ‘wrapped’
Wrapped image payments—payments with images attached that have been wrapped.

Where reference to an image payment is made then it may be wrapped or not, unless otherwise explicitly stated.

An SMS notification to the beneficiary that a payment has been received may include the message and a link to a payment system (e.g. Barclays' Pingit™) to see the message.

Further features may include:
People sending image payments may be able to choose a wrap option, which controls how the payment is displayed when viewed by the recipient.
For customers that can both pay and receive payments within a payment system (e.g. Pingit™), they may receive an SMS to indicate an image payment has been received, with a link to the Pingit app (mobile application). When they launch the Pingit app and enter a valid passcode they will be able to see they have outstanding image payments and can view them through a transaction list. The mobile application may provide additional functions including the initiation of payments through an automated payment system. This may include specifying the payee, amount and the date and time for the transaction.
Images may appear as thumbnails on the transaction list. Images not yet viewed may show as an icon and the payment amount may be hidden. Once viewed, an image may display as a thumbnail and the amount may show.
Users may choose to remove an image once viewed.
If a user chooses not to see an image or chooses to remove an image then it may not be available to them subsequently. On the transaction list the thumbnail may not be displayed.
A mobile device (e.g. smart phone) running the mobile app may make a decision how to display a wrapped image payment base on 1: The wrapping type selected by the sender and 2: the capabilities of the mobile device. E.g. some animations available on the iPhone may not be available on Blackberry.
Images may not be hosted or stored for more than a predetermined number of days (e.g. 30 days), after which they may be deleted from an Image Server. The Payments may also be de-linked after this time. The payment will then no longer be treated as an image payment in the Pingit app. The images and thumbnails on the users' devices (Senders and Recipients) will also be deleted when the retention period has been reached.
Images may be saved preferably to disk in a secure manner (based on an encrypted token).
Access to images may be secure so only the intended recipient can view them.
Content of images may be scanned for inappropriate content (e.g. with NetClean™—only the hashed versions of the images may be compared, the content may not be scanned directly in the clear) and a technical scan (e.g. McAfee™) may check for the presence of any virus or malware.
Where recipients are not registered then image payments will be available to view by them after having registered.
Image files in the following format (as well as others) may be permitted:
PNG, JPEG
Images may be compressed on the mobile device after a user has selected it in order to keep server traffic and image storage space to a manageable size. The compressed size/resolution may be configurable and based on the resolution sizes.
The image does not form part of the relevant payment record. The relevant record simply consists of the payment instruction (pay £X to Y on a certain date).
The image may first be scanned for Virus/Malware. It may then be passed scanned for illegal content.
The system may produce its own hash of the image which will be unique to each customer i.e. hash of image file+customer details. This may be used for auditing purposes and may be recorded during each transaction in an Events Log.
Infrastructure may include a Mobile Gateway hardware security module (HSM).
The deletion of the images on the Image Server may be performed by a scheduler via a scheduled job.
Images may be converted to PNG format on the device i.e. client side. This will be performed by the mobile app.
When the user (Sender or Receiver) requests to delete an image via the mobile app, the associated thumbnail may also be deleted. The image may not be delinked from the payment in this case, however there will be a service call to the Mobile Gateway which will record for the specific user which images they wish to display and which not, so that when the user logs back into the mobile app, and all of the transactions (old and new) are pushed back to the user, those payments from which the images were deleted will no longer be displayed to the specific user.

Payment Flow

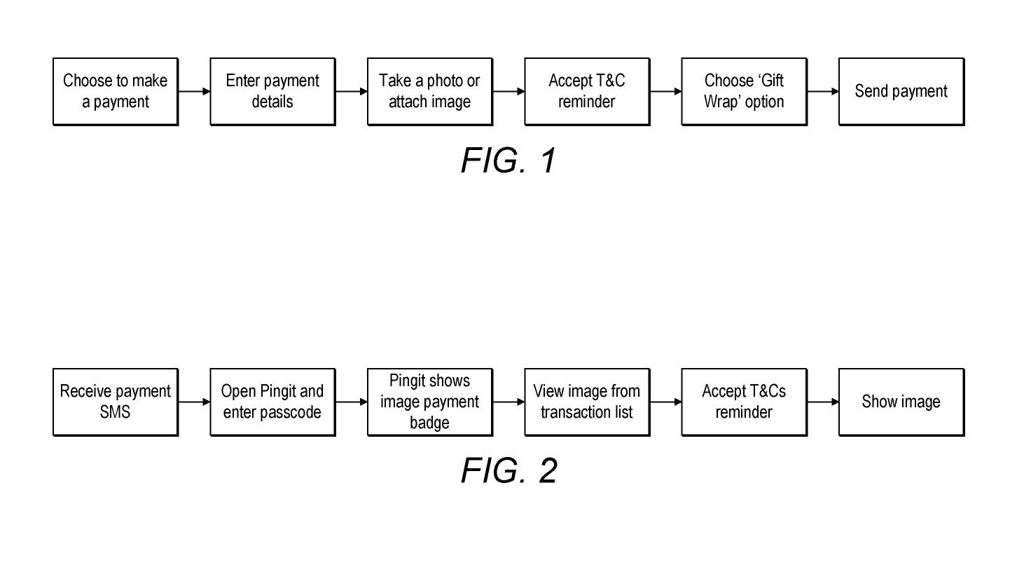

FIG. 1 shows a flow diagram of a method for initiating a payment. This method includes the steps of:
User chooses to make a payment in the mobile app
Enters payment details
Chooses to either take a photo or upload an existing one. If an image is selected, the mobile device will compress it to a predetermined resolution. This is an optional step. A thumbnail version of the image may be created on the payer's mobile device and stored locally. This is so that when the user views the transaction history of sent payments, they can see the thumbnail on the transaction as well as being able to view the image
Accepts terms and conditions (T&C).
Chooses one of the ‘wrap’ options—this is an optional step.
The mobile app (Pingit) makes the payment through a mobile gateway. When payment has been sent, the image is uploaded to a separate Image Server.

Receive Payment Flow—Pay and Receive Registration

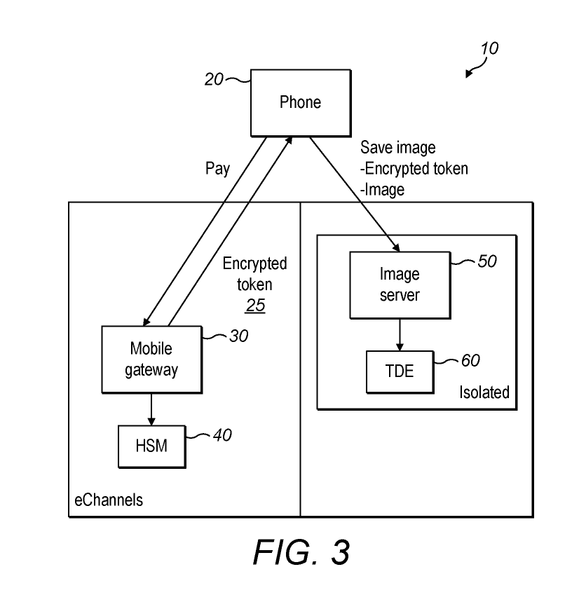

FIG. 2 shows a high level flow diagram of a method for receiving a payment. This method includes the steps of:
Beneficiary receives SMS indicating a payment has been received
Opens mobile app (Pingit) and enters passcode
Pingit checks with the mobile gateway to see if there are any image payments to show to the user.
If payments are available, show the transaction screen with badge to indicate number of image payments available since last login.
Choose image payment from transaction list.
Accept T&Cs reminder
Show image with wrapping animation if selected. At this time a thumbnail version of the image is created on the recipient's device for the purposes of the transaction list.

Multiple Payments with Images

When a user launches the mobile app and authenticates, then they may be shown any image payment messages immediately. In some scenarios there may be more than one message to be displayed. Such a scenario is described below:
Sally sends an image payment to Aaron with an image attached.
Aaron receives an SMS but does not launch the mobile app.
Robert sends an image payment to Aaron with an image attached. Aaron now has two payments with images, neither of which he has seen yet.
Aaron receives SMS to tell them they have a payment from Robert.
Aaron launches the mobile app and enters his passcode. He is then shown the image and message associated with the payment from Robert (based on the fact this is the most recent). When Aaron closes this message he is then shown the image and message associated with the payment from Sally.

Image Sharing and Saving

When images have been received then the user may have the option to do the following:
Save image to phone
Share via email
Share via social media

Options when Viewing Images

The following options may be included:
Pay back
Request—generate a payment request
Remove image—removes the image from the payment
Call
Message
Add contact

Saving Images

Saving images may happen in the following order:
Payment made via gateway
Gateway confirms payment and returns authentication token.
Phone saves image to image server using authentication tokens authorization mechanism.
Phone creates thumbnail and saves to server using same token.

The saving of the images may be done in the background. The user may be provided with an upload status indicating how much of the image is still loading.

When downloading images, the thumbnails may be shown in the transaction list with a placeholder image until the real thumbnail can be downloaded.

In order to allow the customer to manage the storage of thumbnail images on their device, rather than simply forcing the creation of images on the device, there may be a toggle switch to turn thumbnails “On” or “Off”.

When the option is turned on, the thumbnails will be created on the device as normal, however when the option is turned off, thumbnails will no longer be created on the device meaning that all payments will appear as standard payments in the transaction list, however the payments will still have the images associated with them (if any), so that when a payment is opened, the user will be able to view the image associated with that payment, should they wish to do so, except that there will now be no associated thumbnail image for that payment.

Managing Image Status and Transaction List Impacts

When an image payment is first displayed it will be in an ‘Unread image payment’ status. This will show on the transaction list with an icon to identify it as a gift payment and will hide the payment amount.

When an image is viewed the status is set to ‘Read image payment’. This will show on the transaction list as a thumbnail and the payment amount will be shown.

When an the user has declined the T&Cs reminder or chosen to view the image then remove it then the image status is updated to ‘Image removed’. This will not show the thumbnail on the transaction list and the payment should be treated as a standard payment when selected.

Images will be removed after a predetermined period of time (e.g. 30 days) then when the image is removed the payment will no longer be marked as an image payment and will be treated as a standard payment.

Payment Service

A payment system may include the following payment interface(s):

Make Payment

When a payment is made the mobile device may indicate that the payment is an image payment and whether the payment is wrapped or not. If it is wrapped then the wrapping type will be stored. This will be recorded against the payment.

The response to a successful payment may include an encrypted token that may be used by the phone when uploading the image to the image server.

Send SMS

Where an image payment is made then there may be a number of possible SMS messages that may be sent.

Payment History

If a payment is an image payment then the entry in the list of payment history may record this. The mobile device may then use this to identify there is an image associated with the payment and show a thumbnail.

Image Status

To support removal of images and hiding the payment amount and thumbnail when first showing the payment, the image payment may support a number of statuses:
Unread image payment—the initial state of any image payments. Indicate not yet viewed by user.
Read image payment—indicates the user has viewed the image in the mobile app
Image removed—indicates the user has chosen to remove the image from within the mobile app

Gateway Database

The gateway database may need to be able to record that a payment has an image associated with it and its status, the wrapping option specified and store the message sent with the payment.

Error Handling

Error handling mechanisms may apply from the mobile device to the gateway, and back from the mobile gateway to the device. As an example scenario, if a payment with an image is sent by the user and the mobile app crashes, it may depend at which point the mobile app crashed. If the mobile app crashed before sending the payment with image, then no transaction will have been committed.

On the other hand, if the mobile app crashes after the payment with image was sent, then either the payment+image went through and the transaction was committed successfully, or the payment+image did not go through and thus the transaction was not committed i.e. rolled back. The user will be able to check whether the payment+image went through successfully or not by restarting the mobile app and checking the transaction history.

Image Upload, Download and Hosting

Uploading an Image

The end to end system 10 and process for uploading an image is shown in FIG. 3:
When the payment is made for a payment that has an associated image, the operation will return an encrypted token 25 back to the mobile device 20.

The token 25 may contain (for example):

Random number;

AID;

Payment ID;

WrappingType; and

Expiration datetime.
The phone 20 may post the encrypted token 25 to a new, separate application server (Image Server) 50 where the request will be handled

Decrypt the Token 25

Validate each Parameter (Presence, Length, Type)

Check Whether the Token 25 has Expired

If the token 25 has been decrypted and the token validation successful, the image will first be passed to virus and malware scanner (e.g. McAfee™) to be scanned, then it will be passed to NetClean™ to be hashed and processed for illegal content i.e. the hashed version of the image will be compared to the hashed versions of known images.
If no problems with the image are found then it can be saved. The filename will be constituted from the received token data.
A thumbnail version of the image may also be created on the Payer's device for the purpose of displaying it on the sent payments transaction list.
Each image sent may be hashed by the mobile app, the hash value may be sent to a mobile gateway 30 for audit logging—this shall be a client side control.

Mobile Gateway HSM 40

Payment security may be provided by the mobile gateway HSM 40. The image server 50 may be secured by transparent data encryption 60, for example.

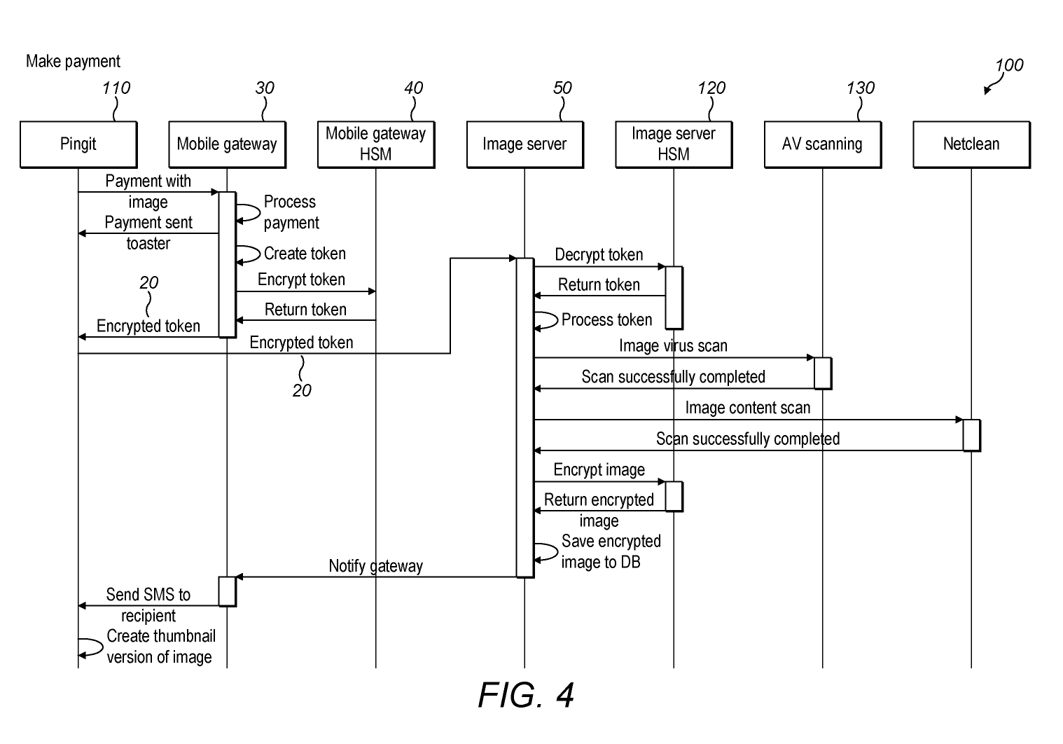

FIG. 4 shows a sequence diagram for the method of making a payment 100. The mobile application (Pingit) 110 interacts with the mobile gateway 30 to initiate a payment with image, receive confirmation and an authentication token for the payment. The mobile gateway 30 interacts with its HSM 40 to create the authentication token.

The image server 50 interacts with its HSM 120 to obtain an image authentication token. Virus scanning and image content scans are carried out by an AV scanner 130 and Netclean (or similar).

Notification of the payment is sent by SMS to the recipient together with an image thumbnail.

The mobile application (Pingit) 110 will retrieve payment details with associated image under the following circumstances:
When a beneficiary receives an SMS for an image payment the SMS will contain a link to Pingit. When clicked the user will enter their passcode, accept image terms and conditions and view the payment details with associated message and image.
From the transaction list when a user views details of a payment with image attached they will see payment details with associated message and image.
A thumbnail version of the image is also created on the Recipient's device for the purpose of displaying it on the received payments transaction list

For a payment with an image (new attribute) the new attribute will be passed to the app. The app will call a new operation on the mobile gateway supplying the payment id and the gateway will return an encrypted token. The app will then request the image from the image server 50 passing the encrypted token. The image server 50 will validate the token. Providing the validation is successful and the token has not expired then the image server 50 will constitute the file name, retrieve it and return to the app.

The mobile gateway 30 will have a table called PaymentHistory that has all transactions on it. Against each transaction will be a flag that will indicate if the transaction has an associated image. This information will be returned to the phone. So if the phone receives 10 transactions, 3 of which have the flag set to true, it knows that its image cache should contain only 3 images and it can delete any that are not returned by using the PaymentID or FileName as a key. Each image sent shall be hashed by the Pingit mobile application

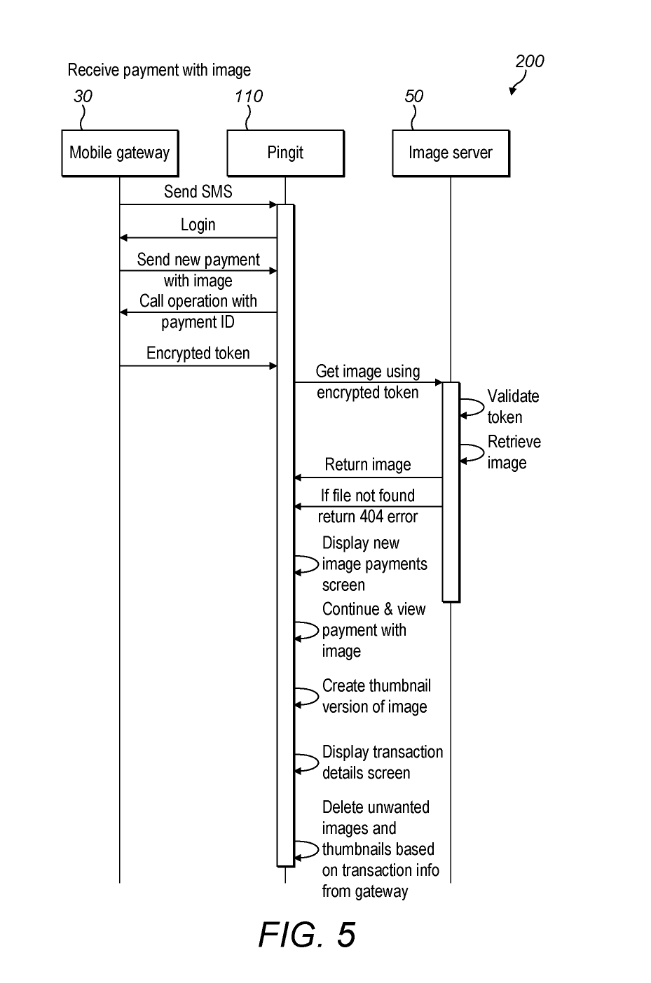

FIG. 5 shows a sequence diagram for receiving a payment. As described with reference to FIG. 4, the mobile gateway 30 sends a SMS confirming that a payment has taken place. This is received by the mobile device running the mobile app (Pingit) 110. Following successful login, the combined payment information and graphical content (an image) is sent to the mobile app 110. The mobile app 110 also receives an authentication token.

The mobile app 110 retrieves the image from the image server 50 using the authentication token. The image server 50 validates the authentication token and retrieves the image, which is then sent to the mobile app 110. Other display actions and housekeeping may also take place (e.g. delete unwanted images and thumbnails).

Images may need to be deleted from the image server 50 within a predetermined period (e.g. 30 days).

Image payments in the mobile gateway database may also need to be updated i.e. de-linked or combined to make them ‘non image payments’ after the same period of time.

When a user logs out of Pingit 110, the image cache is cleared. When a user logs into Pingit 110, the latest transactions (those that have been sent and received) are sent from the mobile gateway 30 to Pingit 110. Payments will be continually delinked from their images when they have reached the retention period, and thus the updated transactions will appear as standard payments, apart from those that are new payments with images, or payments with images that haven't yet reached their retention period.

Once these transactions are received on the recipient's device, if any of these transactions have images associated with them, the images are duplicated and a single thumbnail version of each image is generated. The images and thumbnails are then cached within an image cache.

This will ensure that all payments, with or without images, and their associated thumbnails are in sync with the image server 50 with regards to the retention period. Only the Sender may retain the original image on his/her device i.e. in their image gallery.

The sender's (payer's) device may be updated in the same way as the recipient's (payee's) device. All updated “sent” and “received” transactions may be sent to Pingit 110 i.e. those payments with images that the user has sent and received including standard payments.

The Pingit 110 entity may be the mobile application or preferably the mobile application coupled with its own supporting server.

The following steps occur within an example embodiment of a method for sending an image with a payment:

Image Submission Preparation

1. The Sending Customer selects the JPEG image to be sent with the payment which shall be verified as being of JPEG file type and a valid image file.

2. The Sending mobile application 110 converts the selected image from the JPEG file type to the PNG file type.

3. The Sending mobile application 110 only accepts the an image with a file size no larger than 1.6 Megabytes.

4. The Sending mobile application 110 hashes the image [to provide an integrity value for the original image] and from this point shall not manipulate the image so as to negate the original image hash that is generated.

5. The Sending mobile application 110 submits the payment to the Mobile Gateway 30 along with an indication that the payment includes an image and the original image hash [for binding of the image to the payment].

6. The Sending mobile application 110 shall not transmit the image itself to the Mobile Gateway 30.

7. The Mobile Gateway 30 shall generate an “authentication token” for the Sending mobile application 110 [such that the Sending mobile application 110 can be authenticated to the Image Gateway].

8. The Mobile Gateway 30 shall generate an “image token” for the Sending mobile application 110 [such that only the image bound to the payment, as accepted by the Mobile Gateway 30, will be accepted by the Image Server 50]1

9. The Mobile Gateway 30 shall store the image token's ‘encrypted token data’ component with the payment entry in a Mobile Gateway Database.

10. The Mobile Gateway 30 shall return the authentication token, session keys and the image token to the Sender mobile application 110.

Image Submission

11. The Sender mobile application 110 submits the authentication token to the image server 50.

12. The image server 50 validates the authentication token using the process [to authenticate the Sender mobile application 110].

13. The image server 50 holds in memory, for the duration of the image submission session, the Customer AID and Payment ID extracted from the authentication token [for later validation of the image token].

14. The image server 50 establishes a secure session with the Sender mobile application 110 using the session keys included in the authentication token and extracted during its validation.

15. The Sender mobile application 110 submits the PNG image along with the image token to the image server 50 within the secure session.

16. The image server 50 passes the image to a malware scanner [to attempt to identify malicious code packaged into the image].

17. The image server 50 passed the image to a filtering solution [to attempt to identify undesirable imagery].

18. The image server 50 only continues processing images which are not identified as malicious or known to contain undesirable imagery.

19. The image server 50 only accepts images with a file size no larger than 1.6 Megabytes.

20. The image server 50 only accepts images with a file type of PNG.

21. The image server 50 hashes the received image [to allow checks to be made as to the integrity and acceptability of the image].

22. The image server 50 validates the image token [to authenticate the image as being that bound to the payment].

23. The image server 50 checks that the original image hash, extracted from the image token, matches the received image hash just calculated.

24. The image server 50 generates an expiry timestamp for the image which is 30 days after the timestamp at which it was received.

25. The image server 50 stores the PNG image as a BLOB in the Image Gateway Database (using TDE) along with the associated payment information which includes:

a. Customer AID

b. Payment ID

c. Payment Timestamp

d. Expiry Timestamp

e. Original Image Hash

f. Received Image Hash

g. Image Token's ‘encrypted token data’ component

The following steps occur within an example embodiment of a method for Retrieving an Image with a Payment:

Image Retrieval Preparation.

27. The Receiving mobile application 110 submits a request to retrieve the payment to the Mobile Gateway 30

28. The Mobile Gateway 30 indicates an image is associated with the payment only IF
The image IS NOT marked as undesirable AND
The Receiving Customer DOES accept images AND
The Receiving Customer DOES accept images from the Sending Customer who made the payment.

29. The Receiving mobile application 110 requests the tokens, necessary to access the image from the image server 50, from the Mobile Gateway 30.

30. The Mobile Gateway 30 discards the request for tokens IF
The image IS marked as undesirable OR
The Receiving Customer DOES NOT accept images OR
The Receiving Customer DOES NOT accept images from the Sending Customer who made the payment.

31. The Mobile Gateway 30 generates an “authentication token” for the Receiving mobile application 110 [such that the Receiving mobile application 110 may be authenticated to the Image Gateway 30.

32. The Mobile Gateway 30 generates an “image token” for the Receiving mobile application 110 [such that only the image bound to the payment, as accepted by the Mobile Gateway 30, will be retrieved by the Image Server 50].

33. The Mobile Gateway 30 returns the authentication token, session keys, image token and the original image hash to the Receiving mobile application 110.

Image Retrieval

34. The Receiving mobile application 110 submits the authentication and image tokens to the image server 50

35. The image server 50 validates the authentication token [to authenticate the Retrieving mobile application 110].

36. The image server 50 holds in memory, for the duration of the image retrieval session, the Customer AID and Payment ID extracted from the authentication token [for validation of the image token]

37. The image server 50 checks if the image requested is marked as undesirable and if so shall NOT retrieve the image.

38. The image server 50 retrieves the PNG image from an image server database.

39. The image server 50 hashes the retrieved image [to allow checks to be made as to the integrity of the image].

40. The image server 50 validates the image token [to authenticate the image as being that bound to the payment].

41. The image server 50 checks that the original image hash, extracted from the image token, matches that stored in the image server database.

42. The image server 50 checks that the original image hash, extracted from the image token, matches the retrieved image hash just calculated.

D43. The image server 50 establishes a secure session with the Sender mobile application 110 using the session keys included in the authentication token and extracted during its validation.

44. The image server 50 returns the image to the Receiving mobile application 110 within the secure session.

45. The Receiving mobile application 110 only accepts images with a file size no larger than 1.6 Megabytes

46. The Receiving mobile application 110 only accepts images with a file type of PNG.

47. The Receiving mobile application 110 hashes the received image [to allow checks to be made as to the integrity of the image].

48. The Receiving mobile application 110 checks that the original image hash, provided by the Mobile Gateway 30, matches the received image hash just calculated.

49. The Receiving mobile application 110 displays the received image to the Receiving Customer.

Image Management

Customer

50. The Receiving Customer has the option to not retrieve the image associated with a payment

51. The Receiving Customer has the option to opt out of image retrieval altogether

52. The Receiving Customer has the option to block images from a specific Sending Customer

53. The Receiving Customer has the option to report an image as abuse, within the Receiving mobile application 110, and must specify a reason for the reporting (pick from a list).

54. The Receiving Customer has the option to report an image as undesirable, via the Helpdesk, and must specify a reason for the reporting (pick from a list).

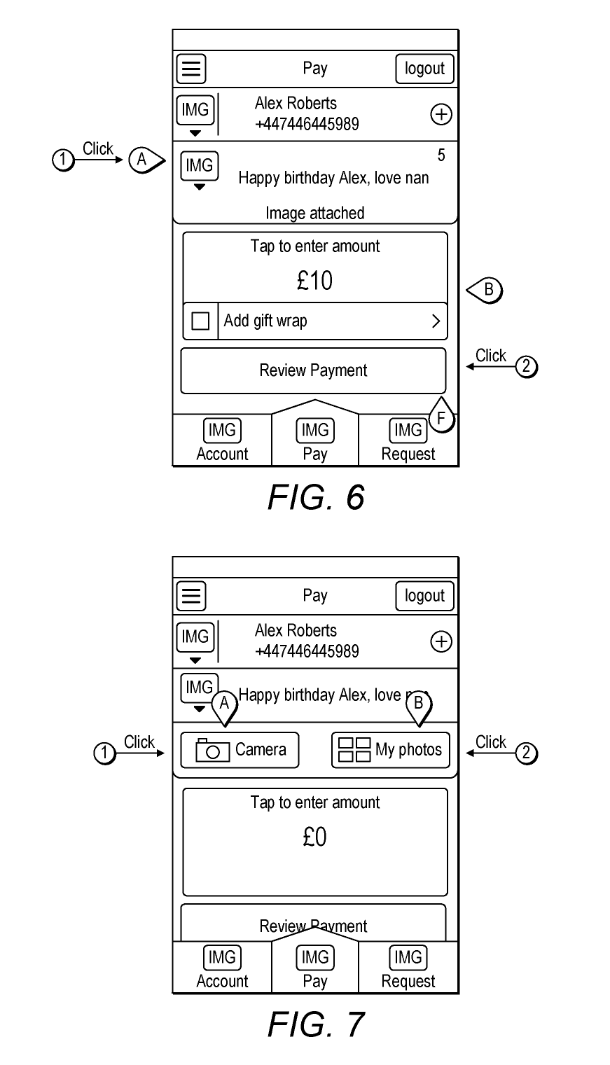

FIGS. 6 to 13 show example screen shots of the mobile application 110. These screen shots show further detail regarding the steps and process taken during various activities for adding graphical content to a payment (or payment information). Screen areas and functions are referred to as A: <function>, B: <function>, C<function>, etc.

FIG. 6 shows a screen shot of a user attaching an image to a payment. A: Add image tab. B: Add amount tab. C: Review payment tab.

FIG. 7 shows a screen shot of the user's options in selecting a stored image or acquiring a new image using an onboard camera. A: Camera button. B: Stored image button.

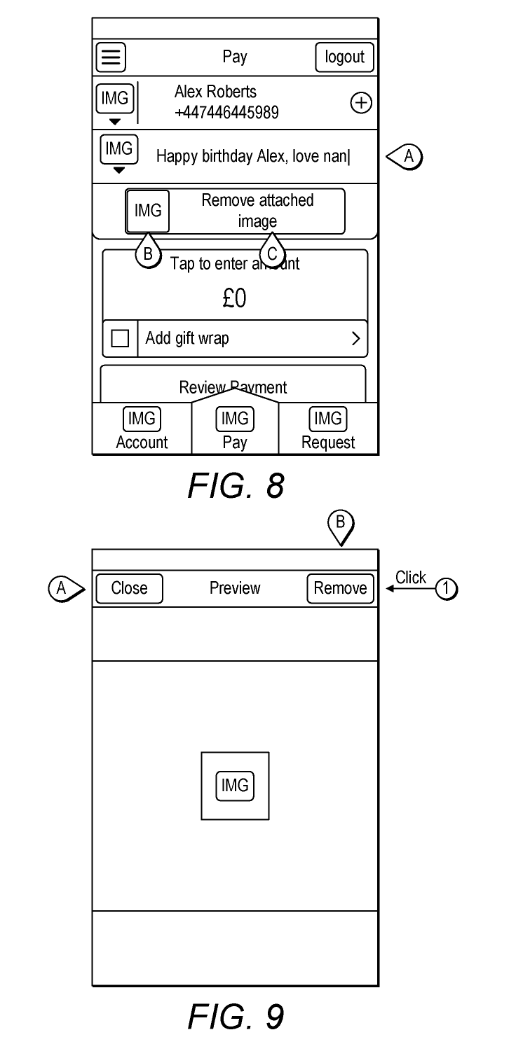

FIG. 8 shows a screen shot of a user adding a message. A: message input area. B: Image thumbnail. C: Remove image button.

FIG. 9 shows a screen shot of an image preview screen. A: Close preview. B: Delete image button.

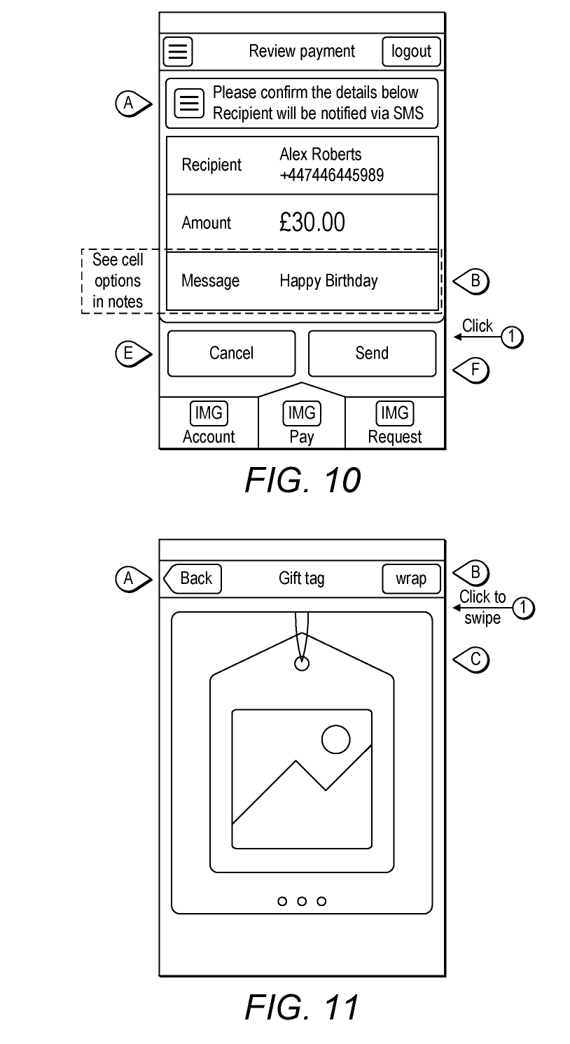

FIG. 10 shows a screen shot of a review payment screen. A: Send SMS to recipient. B: Displayed for message only payment. E: Cancel. F: Send.

FIG. 11 shows a screen shot of a “gift wrapping” screen for the sender. Image payments may be optionally electronically gift wrapped such that the recipient receives an interactive animation which the must be opened (i.e. perform an action) to view their gift. A: Back button. B: Wrap/unwrap toggle. C: Gift wrap preview button.

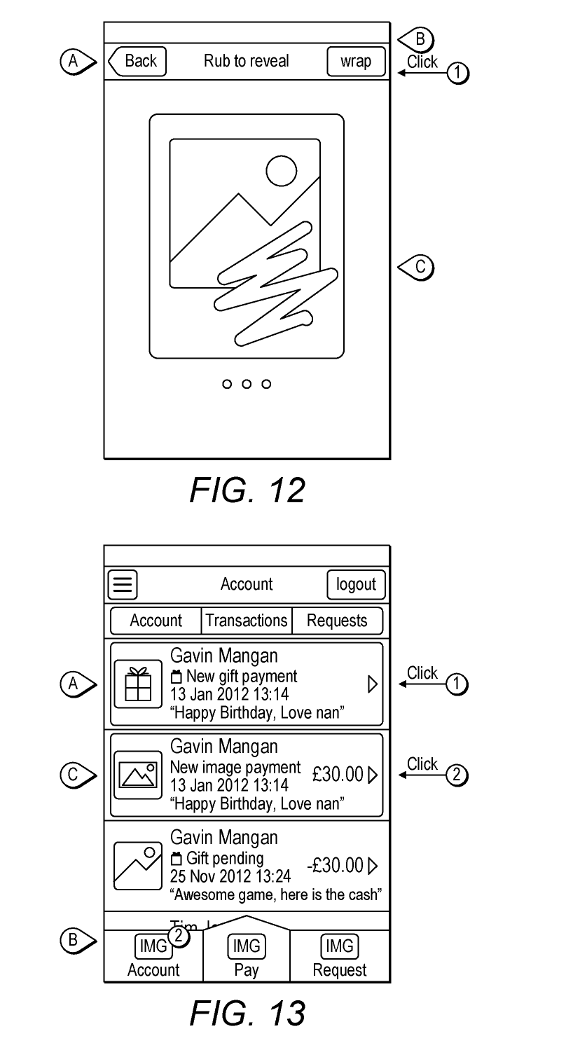

FIG. 12 shows a screen shot of a gift wrap preview screen. This indicates the animated gift wrap selected with reference to FIG. 11. A: Back button. B: Wrap/unwrap toggle. C: Rub-to-real action preview.

FIG. 13 shows a screen shot of an account transaction selection screen. A: Newly receive gift payment. B: Badge displaying number of newly received payments. C: Newly received image payment.

As will be appreciated by the skilled person, details of the above embodiment may be varied without departing from the scope of the present invention, as defined by the appended claims.

For example, the graphical content may be an image, animation or animated action to be performed by the recipient. The payment (or payment information) may relate to a payment that has already been made or requesting a payment from the recipient of the combined payment information and graphical content.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method for transmitting electronic payment information comprising the steps of:
receiving electronic payment information from a first party to a payment;
receiving graphical content from the first party;
combining the graphical content and the electronic payment information; and
transmitting the combined graphical content and the electronic payment information to a second party to the payment.

2. The method of claim 1 further comprising the step of restricting access to the graphical content only to the second party.

3. The method of claim 1 further comprising the step of saving the received graphical content.

4. (canceled)

5. (canceled)

6. The method according to claim 1, wherein the graphical content is hidden from the second party until the second party performs an action.

7. The method of claim 6, wherein the action is rubbing over the image on a touch sensitive screen.

8. The method according to claim 1 further comprising adding a hyperlink to the payment information.

9. The method of claim 8, wherein the hyperlink directs the second party to a web site for administering the payment.

10. (canceled)

11. The method according to claim 1, wherein the graphical content is animated.

12. The method according to claim 1, wherein the first party is a payee and the second party is a payer or wherein the first party is a payer and the second party is a payee.

13. The method according to claim 1 further comprising the step of generating an authentication token following confirmation of the payment.

14. The method of claim 13, wherein the graphical content and the payment information are combined using the authentication token.

15. The method of claim 13 further comprising the step of saving the graphical content together with the authentication token.

16. The method according to claim 1, wherein the graphical content and payment information are combined using an authentication token and further wherein transmitting the combined graphical content and payment information comprises the second party to the payment using the authentication token to request the graphical content.

17. An application for transmitting electronic payment information, the application comprising logic configured to:
receive electronic payment information from a first party to a payment;
receive graphical content from the first party;
combine the graphical content and the electronic payment information; and
transmit the combined graphical content and the electronic payment information to a second party to the payment.

18. The application of claim 17, wherein the application is a mobile application executable on a mobile device.

19. The application of claim 17, wherein combined graphical content and the electronic payment information are transmitted to the second party to the payment through a payment server and an image server.

20. The application according to claim 17, wherein the logic is further configured to receive combined graphical content and electronic payment information.

21. The application of claim 20, wherein the graphical content and the payment information are combined using an authentication token and wherein receiving the graphical content comprises requesting the graphical content using the authentication token.

22. A system for transmitting electronic payment information comprising a server configured to:
receive electronic payment information and graphical content from a first party to a payment;
combine the electronic payment information and graphical content; and
transmit the combined electronic payment information and graphical content to a second party to the payment.

23. The system of claim 22 further comprising a payment server and image server and wherein the combined electronic payment information and graphical content are transmitted through the payment server and image server respectively.

24. The system of claim 22 or claim 23 further comprising a hardware security module, HSM, configured to encrypt the graphical content.

25. (canceled)

26. A non-transitory computer-readable storage medium storing computer readable instructions, which, when read by a computer, instruct the computer to perform the method according to claim 1.

27. (canceled)
